(19) United States
(12) Patent Application Publication
(10) Pub. No.: US 2020/0396187 A1
(43) Pub. Date: Dec. 17, 2020

(54) EMAIL REACTIONS THROUGH EMBEDDED TOKENS

(71) Applicant: Microsoft Technology Licensing, LLC, Redmond, WA (US)

(72) Inventors: Erin Wing Yun Woo, New York, NY (US); Siddhant Mehta, Vancouver (CA); Qasim Muhammad Iqbal, Toronto (CA)

(21) Appl. No.: 16/441,553

(22) Filed: Jun. 14, 2019

(51) Int. Cl. H04L 12/58

(52) U.S. Cl. CPC H04L 51/10; H04L 51/02; H04L 51/18; H04L 51/16; H04L 51/063

(57) ABSTRACT

Techniques for providing email reactions via embedded tokens are disclosed. One example technique includes outputting an original email with an emoji interface that allows selection of emojis at a first computing device. Then, upon detecting selection of one of the emojis, the first computing device can automatically generate a reply email without manual composition. The reply email has data of an email reaction token and the selected one of the multiple emojis. Upon receiving the reply email, a second computing device can determine whether the reply email includes any email reaction token. In response to determining that the received reply email includes the email reaction token, the second computing device can render and surface the one of the multiple emojis on the original email without appending the reply email to an email thread corresponding to the original email.

### BACKGROUND

Today, emojis have become common place in electronic communications both in casual and in professional environments to express ideas, emotions, objects, or meanings. Emojis are small digital images, pictures, icons, or glyphs used in electronic messages to express or represent ideas, emotions, objects, or meanings instead of words. For example, a smiling face emoji can be used to express happiness. On the other hand, a frowny face emoji can be used to express sadness. Other emojis can also be used to express or represent additional facial expressions, objects, places, types of weather, animals, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Though emojis can be used in emails, instant messages, text messages, or other electronic messages to express ideas, emotions, objects, or meanings instead of words, certain electronic communication systems do not provide facilities to allow emojis to be used as comments, responses, or other suitable types of reactions to an original email. For instance, when a user receives and views an original email containing a party invitation from a party organizer, the user typically clicks, presses, or otherwise actuates an interface element (e.g., a “Reply” button) in an email client for generating a reply email. The email client can then display a draft email to the user for composing a reply to the invitation using words and/or emojis in the body of the reply email before sending to the party organizer. Such multi-stepped operations can be inefficient for providing quick responses to simple questions, such as “Can you come to the party tonight?” The reply email can also add clutter to an email thread corresponding to the original email because every reply email is appended to the same email thread. When a large number of users responding to the same invitation, tracking such responses in a large number of reply emails can be cumbersome, time consuming, and prone to error.

Several embodiments of the disclosed technology are directed to an electronic communication system configured to provide a software facility for allowing users to provide comments, responses, or other suitable types of email reactions to an original email using, for example, emojis. As used herein, an “email reaction” generally refers to data or metadata representing a comment, response, reply or other suitable types of statement regarding an original email from a sender. Examples of email reactions can include data or metadata representing likes, dislikes, applauds, etc. that can be represented by one or more corresponding emojis or other suitable images, pictures, animations, and/or text.

In one implementation, the electronic communication system provides an email client that is configured to output an emoji interface for responding to an original email from a sender with email reactions upon receiving the original email. For instance, the email client can be configured to display a dropdown menu for selecting emojis in the original email or other suitable locations in the email client. Upon actuation, the dropdown menu can output a list of emojis for selection by the user. The list of emojis can be recently used emojis, frequently used emojis, preset emojis by the sender, or other suitable list of emojis. Upon receiving a user input that selects one or more of the outputted emojis, the email client can automatically generate a reply email to the original email without the user having to click the “Reply” button and compose a reply email in the email client.

In certain embodiments, the automatically generated reply email can include, inter alia, an embedded email token (referred to as an “email reaction token”) indicating that the reply email represents an email reaction, not another email to be appended to the email thread corresponding to the original email. The email reaction token can include data or metadata that is a part of the reply email. The reply email can also include data identifying the one or more emojis (e.g., using Unicode) and data identifying the original email (e.g., a unique identifier). The email client can then transmit the automatically generated reply email as a regular email having the email reaction token to a sender of the original email according to a suitable email protocol, such as Simple Mail Transfer Protocol (SMTP).

In certain implementations, another email client of the sender can inspect the reply email for any presence of the email reaction token upon reception. Upon detecting that the email reaction token is present or contains a value that indicates that the received reply email represents an email reaction, the email client at the sender can: (i) identify the one or more emojis included in the reply email (e.g., as content of the email reaction token) and output the one or more emojis as interface elements to the original email; and (ii) not render and display the received reply email as a new email to the email thread of the original email in the email client. In certain embodiments, the email client can also be configured to output a notification to the sender regarding the received email reaction, e.g., “John reacted to your message [thumbs up emoji].” In further embodiments, the email client can be configured to output, at the interface elements a number of received email reactions that is expandable to show usernames from whom the email reactions have been received.

Several embodiments of the disclosed technology can thus allow users to efficiently respond to received emails without having to initiate and compose a reply email. For example, instead of composing a reply email, an email client can output one or more emoji interfaces that are configured to allow a user to select one or more emojis (or other suitable types of preset responses) as email reactions to the original email. The email client can then automatically generate a reply email with suitable values for the email reaction token and/or other suitable email tokens in accordance with the user input. The email client can then transmit the reply email as a regular email to the sender. As such, modifications to infrastructure supporting such email exchanges may be avoided. Upon receiving the reply email at the sender, the email client of the sender can render the received reply email as one or more emojis on the original email instead of a new email in the email thread of the original email. The outputted emojis can also allow the sender to easily view who has responded to the original email with what responses. As such, clutter in the email thread can be reduced or even avoided.

### BRIEF DESCRIPTION OF THE DRAWINGS

FIGS. 1A-1D are schematic diagrams illustrating a computing system implementing email reactions through embedded tokens during certain stages of operation in accordance with embodiments of the disclosed technology.

FIG. 2 is a schematic diagram illustrating another computing system implementing emails reactions through embedded tokens during one stage of operation in accordance with embodiments of the disclosed technology.

FIGS. 3A-4B are flowcharts illustrating processes of emails reactions through embedded tokens in accordance with embodiments of the disclosed technology.

FIG. 5 is a computing device suitable for certain components of the computing system in FIGS. 1A-2.

### DETAILED DESCRIPTION

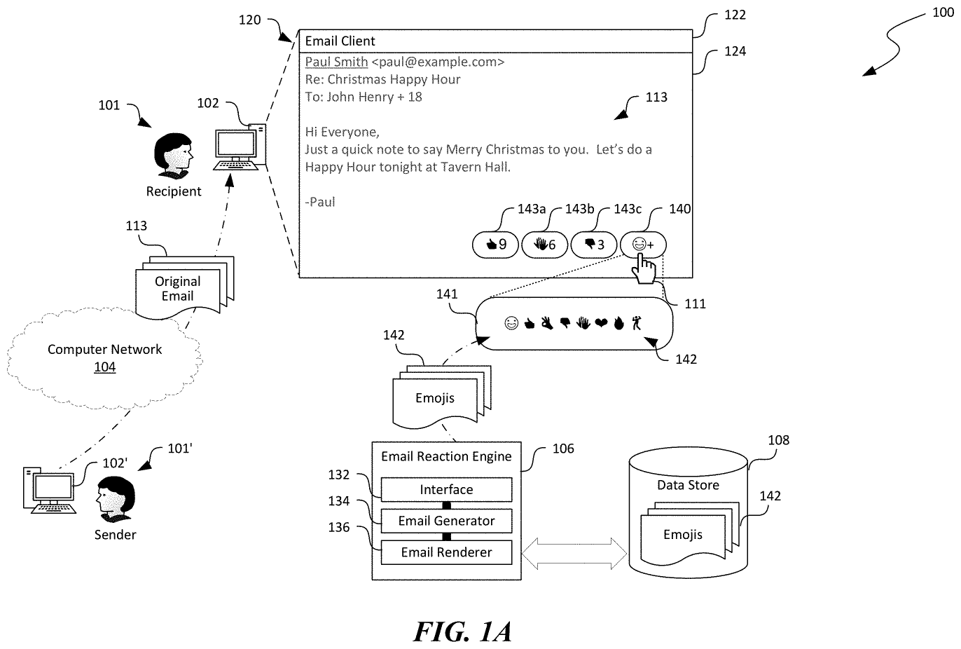

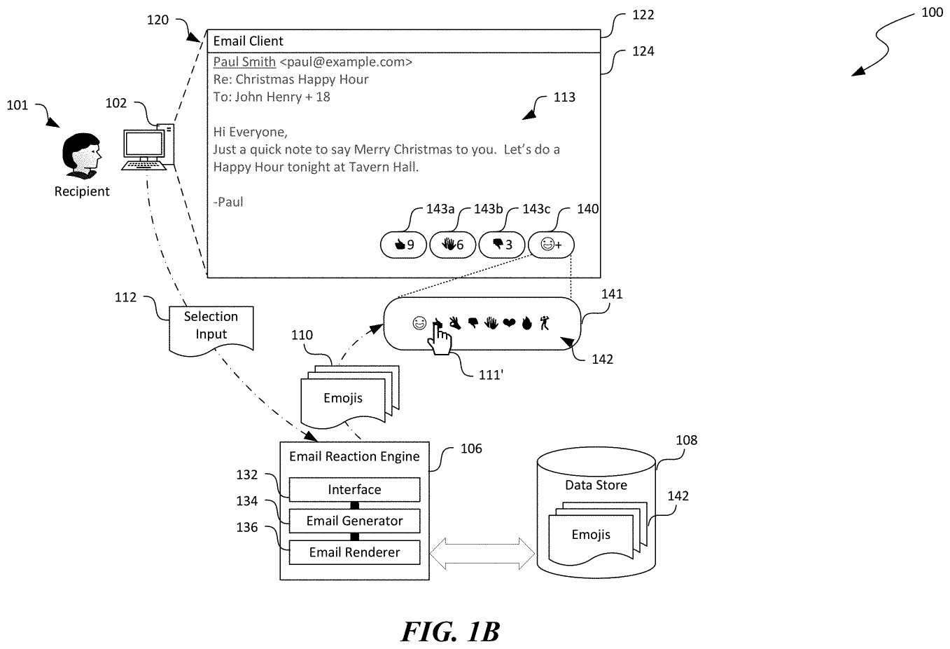

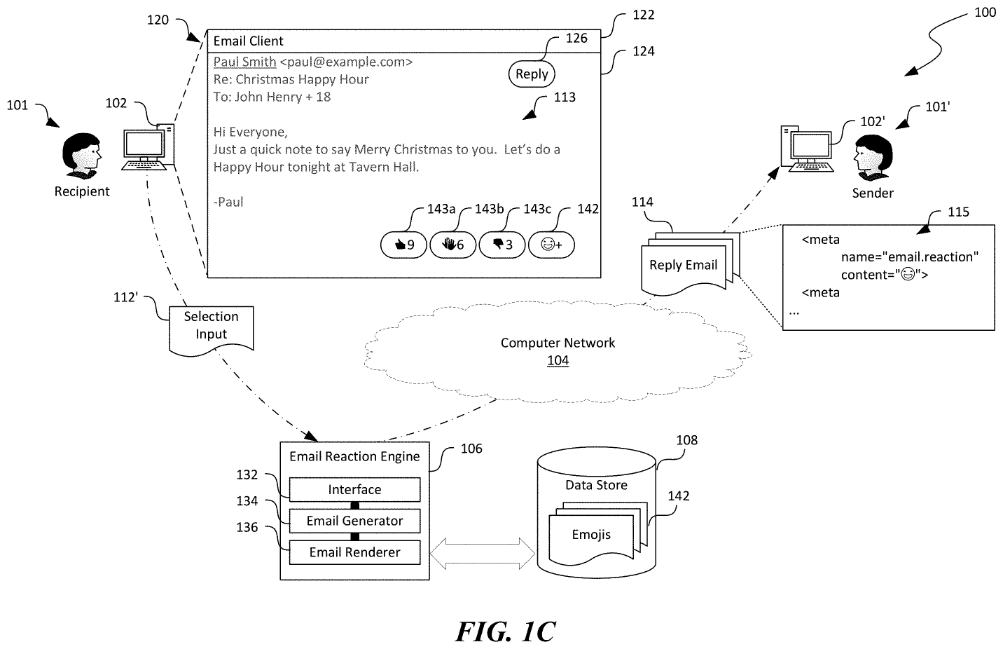

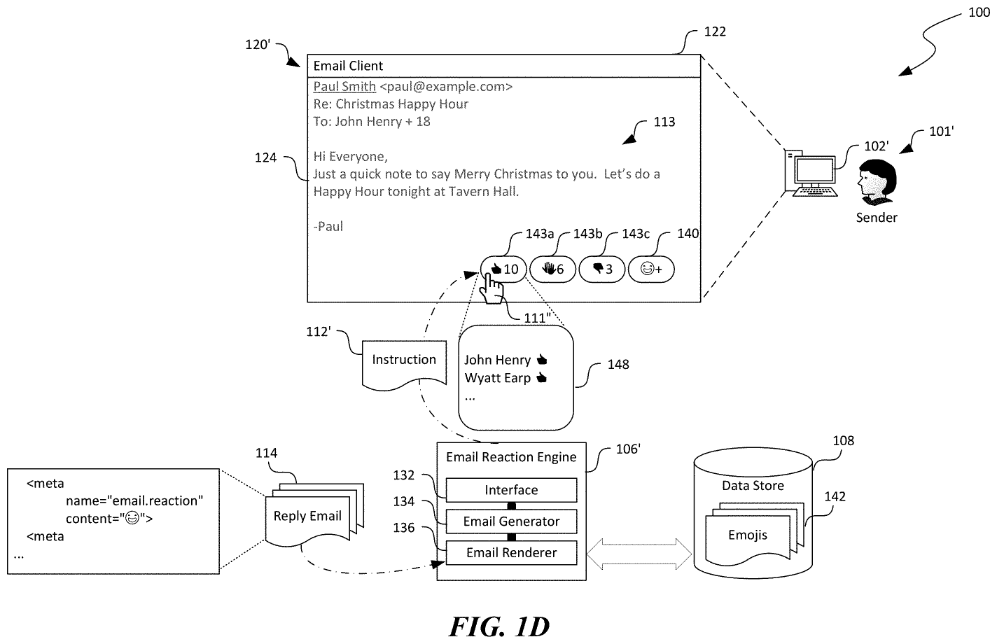

Certain embodiments of systems, devices, components, modules, routines, data structures, and processes for providing emails reactions through embedded tokens in computing and/or electronic communication systems are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1A-5.

As used herein, the term “emoji” generally refers to digital images, pictures, or icons usable in emails, instant messages, text messages, or other suitable types of electronic messages to express or represent ideas, emotions, objects, or meanings. Emojis can be encoded using various encoding standards such as Unicode. For example, a grinning face emoji can have a Unicode of U+1F600. In another example, a thumbs up emoji can have a Unicode of U+1F44D. Also used herein, an “emoji interface” generally refers to a space surfaced on a display (e.g., a screen) of a computing device where interactions between humans and the computing device can occur. Emoji interfaces can include one or more tabs, sections, panes, windows, or other suitable types of user interface elements.

Also used herein, an “email reaction” generally refers to data or metadata representing a comment, response, reply, or other suitable types of statement regarding an original email received from a sender. Examples of email reactions can include data or metadata representing likes, dislikes, applauds, etc. Such email reactions can be represented by one or more emojis, images, pictures, animations, and/or preset text. As discussed in more detail below, embodiments of the disclosed technology are directed to generating, transmitting, and rendering email reactions via embedded email tokens in reply emails.

Also used herein, an “email token” generally refers to data or metadata that is a part of an email and can be a placeholder for representing and/or storing flags, indicators, or other suitable types of values. For instance, an email subject token, e.g., as represented as {{email.subject}}, can be configured to contain data representing a string that is a subject line of an email. In another example, an email reference token, e.g., as represented as {{reference-message-id}}, can be configured to contain data representing another string that is a unique message identifier corresponding to the original email.

In accordance with embodiments of the disclosed technology, in addition to the foregoing and other example email tokens, an email client can also be configured to generate and append to a reply email, an email reaction token. In one embodiment, the email reaction token can be represented as, for example, {{email.reaction}}, that has a name “email.reaction” and is configured to contain data representing one or more values, e.g., Unicode data corresponding to emojis selected by a user as an email reactions. An example hyper-text markup language (HTML) code for an automatically generated reply email having such an email reaction token is as follows:

```
<html>
  <head>
    <meta
      name=“email.reaction”
      content=“ [symbol]   ”>
    <meta
      name=“reference-message-id”
      content=“CY4PR19MB00697EE6DA7B78064B5A6AD0AF140”>
  </head>
  <body>

[symbol]

  </body>
</html>
```

As shown above, the example HTML code of the reply email includes an email reaction token having a name of “email.reaction” and a content of “ [symbol] ”. In the illustrated example, the presence of the email reaction token can be configured to indicate that the reply email is an email reaction to the original email which is identified by an email reference token, i.e., metadata with a name of “reference-message-id” that has a content of a string of “CY4PR19MB00697EE6DA7B78064B5A6AD0AF140.” The presence of the email reaction token can be configured to indicate to an email client to render the reply email as one or more emojis, i.e., “ [symbol] ” to the original email, not as a regular email appended to an email thread of the original email. Though the body of the example reply email above includes another copy of the emoji, i.e., “ [symbol] ”, in other examples, the body of the reply email can also contain other suitable text or can be blank.

In other implementations, the email reaction token can also be configured to contain a Boolean value of either zero or one, indicating either the reply email is an email reaction to the original email and to be rendered as one or more emojis, or as a regular email to be appended to the email thread of the original email. The email client can be configured to further generate and append to the reply email an email emoji token, e.g., as represented as {{emojis}}, that is configured to contain one or more emojis for the email reaction, or identify the emojis for the email reaction in the body of the reply email, as shown in the example above. In further implementations, the email reaction token can be configured to as a portion of the header, body, or other suitable parts of the reply email or have other suitable configurations.

Further used herein, an “email thread” generally refers to a single email conversation that starts with an original email as a beginning of the conversation and includes all of the subsequent emails that are responses, forwards, or otherwise pertaining to that original email. As discussed in more detail below, in accordance with embodiments of the disclosed technology, only reply emails not indicated by an embedded email reaction token as an email reaction are appended or otherwise added to an email thread started by the original email. Reply emails indicated by an embedded email reaction token as an email reaction are rendered and surfaced as one or more emojis (or other suitable email reactions) on the original email in the email thread.

Emojis can be used in emails, instant messages, text messages, or other electronic messages to express ideas, emotions, objects, or meanings instead of words, certain electronic communication systems do not provide facilities to allow emojis to be used as comments, responses, or other suitable types of reactions to an original email. For instance, when a user receives and views an original email containing a party invitation from a party organizer, the user typically actuates an interface element a “Reply” button in an email client for generating a reply email. The email client can then display a draft email to the user for composing a reply to the invitation using words and/or emojis in the body of the reply email before sending to the party organizer. Such multi-stepped operations can be inefficient for providing quick responses to simple questions, such as “Can you come to the party tonight?” The reply email can also add clutter to an email thread corresponding to the original email because every reply email is appended to the same email thread. When a large number of users responding to the same invitation, tracking such responses in a large number of reply emails can be cumbersome, time consuming, and prone to error.

Several embodiments of the disclosed technology are directed to an electronic communication system configured to provide a software facility for allowing users to provide comments, responses, or other suitable types of email reactions to an original email using, for example, emojis. In one implementation, the electronic communication system provides an email client that is configured to output an emoji interface for responding to an original email from a sender with email reactions upon receiving the original email. Upon receiving a user input that selects one or more of the outputted emojis, the email client can automatically generate a reply email to the original email without the user having to click the “Reply” button and compose a reply email in the email client. The automatically generated reply email can include, inter alia, an embedded email reaction token indicating that the reply email represents an email reaction, not another email to be appended to the email thread corresponding to the original email. Upon receiving the reply email at the sender, the email client of the sender can render and surface the received reply email as one or more emojis on the original email instead of a new email in the email thread of the original email. As such, several embodiments of the disclosed technology can allow users to efficiently respond to received emails without manual composition and reduce clutter in the email client of the sender, as described in more detail below with reference to FIGS. 1A-5.

FIGS. 1A-1D are schematic diagrams illustrating a computing system 100 implementing email reactions through embedded tokens during certain stages of operation in accordance with embodiments of the disclosed technology. In FIGS. 1A and 1n other Figures herein, individual software components, objects, classes, modules, and routines may be a computer program, procedure, or process written as source code in C, C++, C #, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

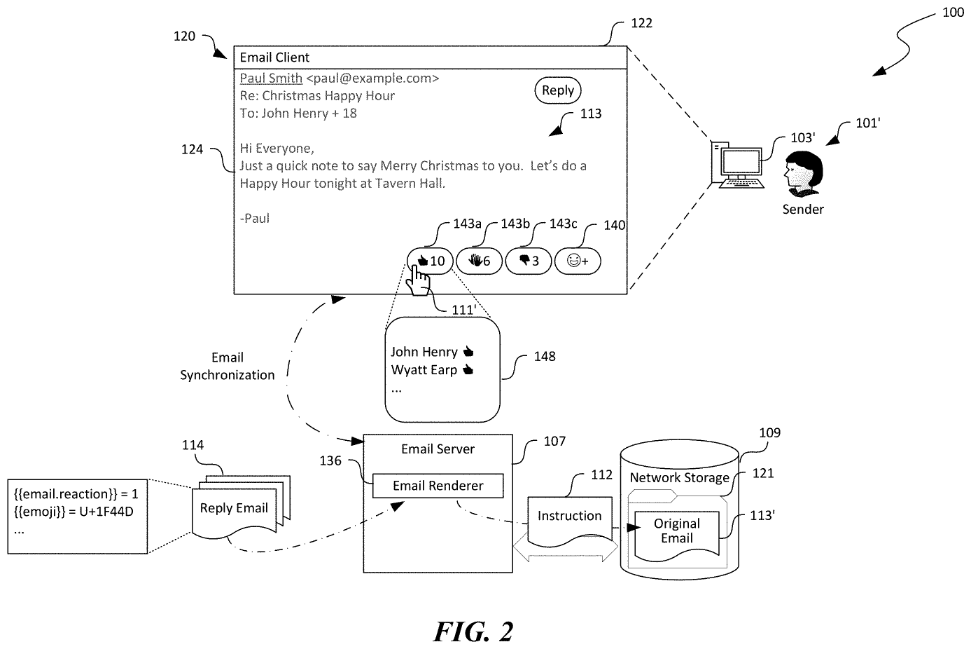

As shown in FIG. 1A, the computing system 100 can include a first client device 102 corresponding to a recipient 101 interconnected to a second client device 102′ corresponding to a sender 101′ via a computer network. Both the first and second client devices can include one or more processor executing suitable codes to provide an email client 120 configured to receive, render, compose, send, or otherwise facilitate email operations on the first and second client devices 102. Though not shown in FIG. 1A, the computing system 100 can also include one or more email servers 107 (shown in FIG. 2) that is a part of the computer network 104 and configured to facilitate exchange of emails between the first and second client devices.

The client devices 102 can each include a computing device that facilitates the sender 101′ and the recipient 101 to exchange emails via the computer network 104. In the illustrated embodiment, the client devices 102 each includes a desktop computer. In other embodiments, the client devices 102 can also include laptop computers, tablet computers, smartphones, or other suitable computing devices. Though one sender and one recipient 101 and 101′ are shown in FIG. 1A for illustration purposes, in other embodiments, the computing system 100 can facilitate email exchanges among other suitable numbers of senders and recipients 101 and 101′.

In the illustrated example, the computer network 104 facilitates transmission of an original email 113 from the second client device 101′ to the first client device 101. As shown in FIG. 1A, the email client 120 at the first client device 102 can be configured to render and surface the received original email 113 via a display (e.g., a screen) of the first client device 101. In the illustrated example, the email client 120 can be configured to provide a user interface 122 that includes a display area 124 (e.g., a window) outputting various headers, body text, and/or other suitable content of the original email. For instance, the illustrated example original email 113 includes a name of the sender (i.e., “Paul Smith,” a subject (i.e., “Christmas Happy Hour”), a name of the recipient (i.e., “John Henry,” and a body having text that is an invitation for a party (i.e., “Hi Everyone, Just a quick note to say Merry Christmas to you. Let's do a Happy Hour tonight at Tavern Hall.—Paul”).

In accordance with embodiments of the disclosed technology, the email client 120 can also be configured to output an emoji interface 142 that is configured to allow the recipient 101 to view and select one or more emojis 142 as an email reaction to the original email 113. For example, as illustrated in FIG. 1A, the emoji interface 140 can a button shown as a smiley face emoji with a plus sign. Upon receiving a user input, as represented in FIG. 1A by the cursor 111, a pop-up menu 141 that includes additional emojis 142 for selection by the recipient 101 can be provided. In other examples, the emoji interface 140 can also include dropdown menu or other suitable interface elements.

As shown in FIG. 1A, the email client 120 can also be configured to output optional reaction interfaces 143 (identified as first to third reaction interfaces 143a-143c, respectively) representing various email reactions to the original email 113 by other recipients (not shown). For instance, in the illustrated example, the optional reaction interfaces 143 can include a first reaction interface 143a having a thumbs-up emoji 142 with a number (i.e., 9) representing nine other recipients have provided a thumbs-up to the invitation. The optional reaction interfaces 143 can also include a second reaction interface 143b having a clipping emoji 142 with another number (i.e., 6) and a third reaction interface 143c having a thumbs-down emoji 142 with a further number (i.e., 3). In other examples, one or more of the emojis 142 may be omitted, and/or the optional reaction interfaces 143 can include additional emojis 142 (e.g., a fire emoji) with corresponding numbers representing a quantity of recipients who have provided such an email reaction.

In the example in FIG. 1A, the emoji interface 140 and the optional reaction interfaces 143 are surfaced on a button portion of the original email 113 for illustration purposes. In other examples, one or more of the emoji interface 140 or the optional reaction interfaces 143 can be surfaced on a menu bar (not shown) of the email client 120, a top portion of the original email 113, or in other suitable locations in the user interface 122 of the email client 120. In further examples, one or more of the emoji interface 140 and the optional reaction interfaces 143 can also be represented as text, animation, or other suitable interface elements.

As shown in FIG. 1A, the computing system 100 can include an email reaction engine 106 operatively coupled to a data store 108 containing records of emojis 142 (e.g., glyphs with corresponding Unicode identifiers). The email reaction engine 106 can be configured to facilitate email reactions via embedded email tokens. In certain embodiments, the email reaction engine 106 can be integrated with and become a part of the email client 120 on the first and second client devices 102. In another embodiment, at least one of the components of the email reaction engine 106 can be hosted in an operating system (not shown) of the first or second client device 102, in the email server 107 (FIG. 2), in a remote server (not shown) and provided as a cloud computing service to the recipient 101, or have other suitable configurations. For ease of description, the following examples are directed to that the email reaction engine 106 being a part of the email client 120.

The email reaction engine 106 can include an interface component 132, an email generator 134, and an email renderer 136. Though particular components of the email reaction engine 106 are shown in FIG. 1A, in other embodiments, the email reaction engine 106 can also include additional and/or different components.

The interface component 132 can be configured to output the emoji interface 140 and the optional reaction interfaces 143 associated with the original email 113 on the email client 120. In certain embodiments, the interface component 132 can be configured to output the emoji interface 140 at a default location in the user interface 122 of the email client 120. In other embodiments, the interface component 132 can be configured to output the emoji interface 140 at a menu bar (not shown) of the email client 120 or other suitable locations. In further embodiments, the interface component 132 can also be configured to parse metadata of the original email 113 to identify the emojis 142 and corresponding numbers of previous responses and output the identified emojis 142 and the corresponding numbers as the optional reaction interfaces 143 on the user interface 122.

The interface component 132 can also be configured to render and surface additional emojis 142 for selection by the recipient 101. For example, as shown in FIG. 1A, in response to receiving a user input (as represented by the cursor 111), the interface component 132 can be configured to provide the pop-up menu 141 that includes additional emojis 142 for selection by the recipient 101. Though particular emojis 142 are illustrated in FIG. 1A, in other embodiments, the pop-up menu 141 (or other suitable types of user interfaces) can also include additional and/or different emojis 142 organized in pages, tabs, or other suitable interface elements.

The interface component 132 can further be configured to detect the recipient 101 selecting one or more of the emojis 142 in the emoji interface 140 and/or the pop-up menu 141. As shown in FIG. 1B, the interface component 132 can be configured to receive a selection input 112 from the recipient 101 selecting a thumbs-up emoji 142 from the pop-up menu 141. In response to receiving the selection input 112, the interface component 132 can be configured to indicate to the email generator 134 to automatically generate a reply email 114 (shown in FIG. 1C) that is an email reaction based on the selected emoji 142.

In response, as shown in FIG. 1C, the email generator 134 can be configured to generate a reply email 114 without manual composition by the recipient 101 via, for instance, actuating the “Reply” button 126 to compose a new email in the email client 120. In one implementation, the email generator 134 can be configured to generate a reply email 114 having, inter alia, an embedded email reaction token 115 indicating that the reply email 114 represents an email reaction, not another email to be appended to the email thread corresponding to the original email 113 (FIG. 1A). The email reaction token 115 can include data or metadata that is a part of the reply email 114. For example, in the illustrated embodiment, the email reaction token 115 includes metadata that has a name of “email.reaction” and a value of “ [symbol] ” In other examples, the email reaction token 115 can include other suitable types of data or metadata embedded in the reply email 114. The reply email 114 can also include data identifying the one or more emojis (e.g., using Unicode) and data identifying the original email 113 (e.g., a unique identifier).

Upon completion of generating the reply email 114, the email client 120 at the first computing device 102 can then transmit the automatically generated reply email 114 as a regular email having the email reaction token 115 to the sender 101′ of the original email 113 according to a suitable email protocol, such as Simple Mail Transfer Protocol (SMTP). As shown in FIG. 1D, upon receiving the reply email 114 at the second client device 102′, the email renderer 136 of the email reaction engine 106′ at the email client 120′ of the second client device 102′ can be configured to inspect the reply email 114 to determine whether the reply email 114 includes any email reaction token 115 that indicates the reply email 114 is an email reaction instead of a regular email. In the illustrated example, the email renderer 136 can determine that the reply email 114 indeed includes an email reaction token 115 that indicates the reply email 114 as an email reaction.

In response to such a determination, the email renderer 136 can be configured to identified one or more emojis 142 (FIG. 1A) corresponding to the email reaction as content of the email reaction token 115, content of a body section of the reply email 115, or via other suitable techniques. The email renderer 136 can then be configured to render and surface the identified emojis 142 on the original email 113 instead of appending the reply email 114 as a new email in an email thread (not shown) corresponding to the original email 113. In response to determining that the reply email 114 is not an email reaction based on a lack of the email reaction token 115 or a value of the email reaction token 115, the email renderer 136 can be configured to render and surface the reply email 114 as a new email in the email thread corresponding to the original email 113 in the email client 120′.

In certain embodiments, the email renderer 136 can be configured to determine whether the identified emoji 142 (i.e., thumbs-up emoji) has been received from other recipients (not shown). In response to determining that the identified emoji 142 has been received from other recipients, the email renderer 136 can be configured to issue an instruction 112′ to update the corresponding optional reaction interface 143 with a new quantity. For instance, in the illustrated embodiment, the email renderer 136 can be configured to update the number of the first reaction interface 143a corresponding to the thumbs-up emoji 142 from “9” to “10.” In response to determining that the identified emoji 142 has not been received from other recipients, the email renderer 136 can be configured to render and surface a new reaction interface 143 with a corresponding number (e.g., “1”).

In further examples, the email renderer 136 can also be configured to provide a list of recipients who have provided the same corresponding email reactions represented by the emojis 142. For instance, upon receiving a user input as represented by the cursor 111″, the email renderer 136 can be configured to render and surface on the second client device 102′ a pop-up window showing names of recipients who have provided the same email reactions. As such, the sender 101′ can efficiently determine who have provided what response without scrolling through a chain of emails in the email thread. In yet further examples, the email renderer 136 can be configured to render and surface a notification (not shown) identifying the original email 113, the recipient 101 of the first computing device 102, and the selected one of the emojis 142 by the recipient 101 of the first computing device 102.

Several embodiments of the disclosed technology can thus allow the recipient 101 to efficiently respond to the received original email 113 without having to initiate and compose a reply email. For example, instead of composing a reply email, the email client 120 can output one or more emoji interfaces 140 that are configured to allow the recipient 101 to select one or more emojis 142 as email reactions to the original email 113. The email client 120 can then automatically generate a reply email 114 with suitable values for the email reaction token 115 and/or other suitable email tokens in accordance with the user input. The email client 120 can then transmit the reply email 114 as a regular email to the sender. As such, modifications to infrastructure supporting such email exchanges may be avoided. Upon receiving the reply email 114 at the second client device 102′ of the sender 101′, the email client 120′ of the sender 101′ can render the received reply email 114 as one or more emojis 142 on the original email 113 instead of a new email in the email thread of the original email 113. The outputted emojis 143 can also allow the sender to easily view who has responded to the original email 113 with what responses. As such, clutter in the email thread of the original email 113 can be reduced or even avoided.

Even though the email renderer 136 is illustrated in FIGS. 1A-1C as a part of the email reaction engine 106 residing on the first or second client device 102 and 102′, in other embodiments, the email renderer 136 can also be hosted on an email server 107 configured to facilitate email exchange between the first and second client devices 102 and 102′. For example, as shown in FIG. 2, upon receiving the reply email 114 from the first client device 102 (FIG. 1A), the email renderer 136 residing on the email server 107 can be configured to perform rendering and surfacing of the reaction interfaces 143 described above with reference to FIG. 1D to a copy of the original email 113′ at a network folder 121 of the sender 101′ in a network storage 109 operatively coupled to the email server 107. Upon completion of the rendering and surfacing operations, the updated reaction interfaces 143 can be transmitted to a local copy of the original email 113 at the second client device 102′ via email synchronization or other suitable techniques.

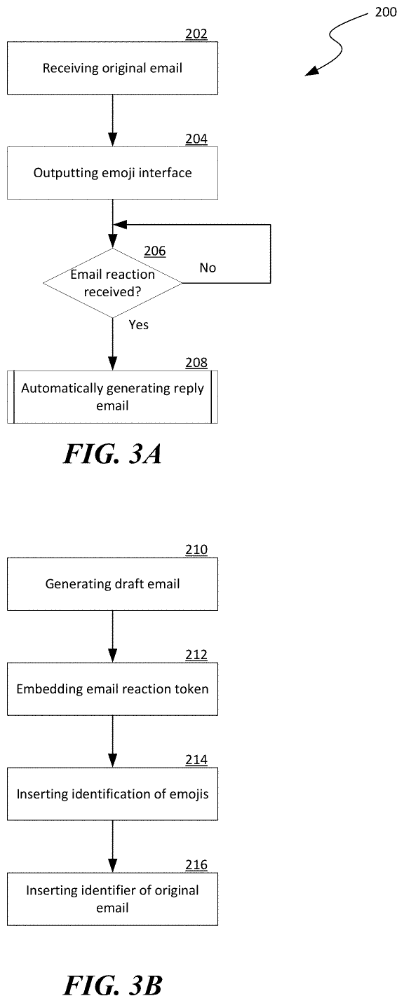

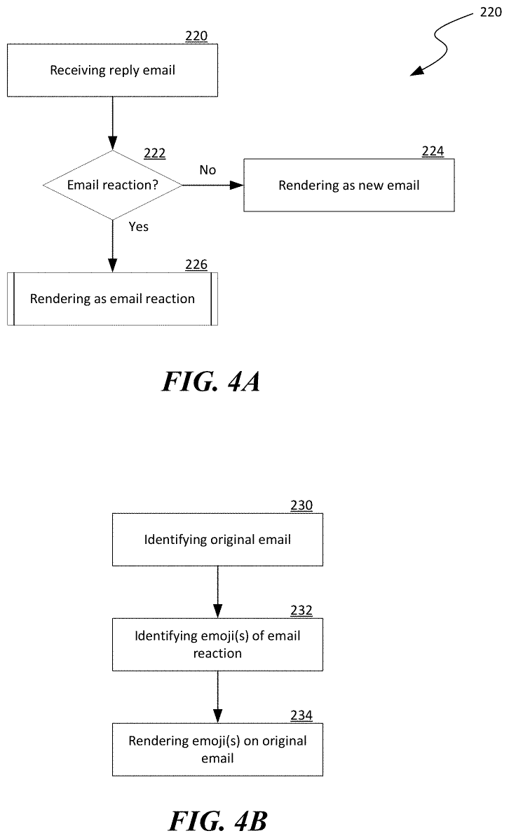

FIGS. 3A-4B are flowcharts illustrating processes of emails reactions through embedded tokens in accordance with embodiments of the disclosed technology. Even though the processes are described below in the context of the computing system 100 described above with reference to FIGS. 1A-2, embodiments of the processes can also be implemented in other computing systems with additional and/or different components.

As shown in FIG. 3A, a process 200 can include receiving an original email from a sender at stage 202. The process 200 can then include outputting an emoji interface along with the received original email at stage 204. Example emoji interfaces are described above with reference to FIGS. 1A-2. The process 200 can then include a decision stage 206 to determine whether an email reaction is received via the emoji interface. In response to determining that an email reaction is not received, the process 200 reverts to the decision stage 206; otherwise, the process 200 proceeds to automatically generating a reply email based on the received email reaction at stage 208. Example operations of automatically generating the reply email are described below with reference to FIG. 3B.

As shown in FIG. 3B, example operations of automatically generating the reply email can include generating a draft email according to, for instance, HTML, at stage 210. The operations can then include embedding an email reaction token in the draft email at stage 212. Example email reaction tokens are described above with reference to FIGS. 1A-2. The operations can then include inserting an identification of one or more emojis into the draft email at stage 214 and inserting an identifier of the original email at stage 216.

FIG. 4A is a flowchart illustrating process of rendering a received reply email in accordance with embodiments of the disclosed technology. As shown in FIG. 4A, a process 220 can include receiving a reply email to an original email at stage 220. The process 220 can then include a decision stage 222 to determine whether the reply email includes data or metadata that represents an email reaction. Various techniques of performing such a determination are described above with reference to FIGS. 1A-2. In response to determining that the reply email includes data or metadata that represents an email reaction, the process 220 can include rendering and surfacing the reply email as an email reaction without appending the reply email as a new email in an email thread of the original email at stage 226. Example operations of rendering the reply email as an email reaction are described below with reference to FIG. 4B. In response to determining that the reply email does not include data or metadata that represents an email reaction, the process 220 can include rendering the reply email as a new email in the email thread of the original email at stage 224.

As shown in FIG. 4B, example operations of rendering the reply email as an email reaction can include identifying an original email to which the email reaction applies at stage 230. In certain embodiments, such an identification can be based on metadata, such as a reference message ID included in the reply email, as described above with reference to FIGS. 1A-2. In other embodiments, such an identification can be made via other suitable techniques. The example operations can then include identifying one or more emojis corresponding to the email reaction at stage 232. Example techniques of identifying the one or more emojis are described above with reference to FIGS. 1A-2. The example operations can then include rendering the identifying one or more emojis on the original email in an email client instead of appending the reply email as a new email in the email thread of the original email at stage 234, as described in more detail above with reference to FIG. 1D.

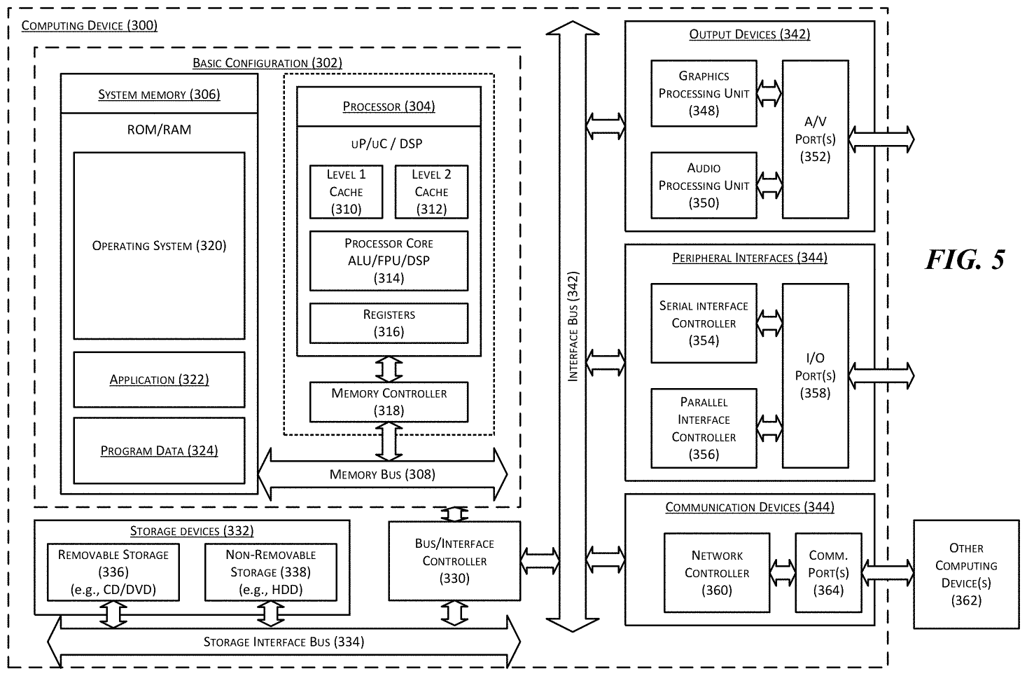

FIG. 5 is a computing device 300 suitable for certain components of the computing system 100 in FIGS. 1A-2. For example, the computing device 300 can be suitable for the computing device 102 of FIGS. 1A-1D or the email server 107 in FIG. 2. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 4 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for providing email reactions via embedded tokens in an electronic communication system having a first computing device and a second computing device interconnected via a computer network, the method comprising:
upon receiving, at the first computing device, an original email transmitted from the second computing device via the computer network,
outputting, on a display of the first computing device, the original email with an emoji interface configured to display and receive selection of one or more emojis from a user; and
upon detecting selection of one of the multiple emojis by the user via the emoji interface,
automatically generating a reply email to the received original email without manual composition by the user, the reply email having data or metadata representing an email reaction token, the selected one of the multiple emojis, and an identifier of the original email; and
transmitting the reply email to the second computing device via the computer network; and
upon receiving, at the second computing device, the reply email,
determining whether the received reply email includes any email reaction token indicating that the reply email is an email reaction; and
in response to determining that the received reply email includes the email reaction token, rendering the selected one of the multiple emojis on the original email without appending the reply email to an email thread corresponding to the original email.

2. The method of claim 1 wherein outputting the original email and the emoji interface includes outputting the original email and the emoji interface configured to display and receive selection of one or more emojis from the user, and to display a number of additional users who have responded with the one or more emojis to the original email.

3. The method of claim 1 wherein automatically generating the reply email includes inserting, into the reply email, data representing a name of the email reaction token and data representing the selected one of the multiple emojis as content of the email reaction token.

4. The method of claim 1, further comprising outputting, on the second computing device, a notification identifying the original email, the user of the first computing device, and the selected one of the emojis by the user of the first computing device.

5. A method for providing email reactions via embedded tokens in an electronic communication system having a first computing device and a second computing device interconnected via a computer network, the method comprising:
upon receiving, at the first computing device, an original email transmitted from the second computing device via the computer network,
outputting, on a display of the first computing device, the original email along with an emoji interface configured to display and receive selection of one or more emojis from a user; and
upon detecting selection of one of the multiple emojis by the user via the emoji interface,
automatically generating a reply email to the received original email without manual composition by the user, the reply email having data or metadata representing an email reaction token and the selected one of the multiple emojis, wherein the email reaction token indicating that the reply email is to be rendered as the selected one of the multiple emojis on the original email, not as a new email appended to an email thread corresponding to the original email; and
transmitting the automatically generated reply email to the second computing device via the computer network to be rendered at the second computing device as the selected one of the multiple emojis on the original email.

6. The method of claim 5 wherein outputting the original email along with the emoji interface includes outputting the original email along with the emoji interface configured to display and receive selection of one or more emojis from the user, and to display a number of additional users who have responded with the one or more emojis to the original email.

7. The method of claim 5 wherein automatically generating the reply email includes inserting, into the reply email, data or metadata representing a name of the email reaction token and data representing the selected one of the multiple emojis as content of the email reaction token.

8. The method of claim 5 wherein automatically generating the reply email includes inserting, into the reply email, data or metadata representing a name of the email reaction token and data representing the selected one of the multiple emojis as content of the email reaction token or as content of a body section of the reply email.

9. The method of claim 5 wherein automatically generating the reply email includes inserting, into the reply email, data or metadata representing a name of the email reaction token, data representing the selected one of the multiple emojis as content of the email reaction token or as content of a body section of the reply email, and data representing a unique identifier of the original email.

10. A computing device for providing email reactions via embedded tokens in an electronic communication system, the computing device comprising:
a processor; and
a memory having instructions executable by the processor to cause the computing device to provide an email client configured to output received emails organized in corresponding email threads and to:
receive a reply email to an original email transmitted from the computing device to another computing device;
determine whether the received reply email includes data or metadata representing an email reaction token indicating that the received reply email is an email reaction representing a comment to the original email; and
in response to determining that the received reply email includes data or metadata representing an email reaction token,
identify, in the reply email, one or more emojis corresponding to the email reaction to the original email; and
render and surface the identified one or more emojis as an emoji interface corresponding to the original email in the email client without outputting, in the email client, the received reply email as a new email to an email thread corresponding to the original email.

11. The computing device of claim 10 wherein the memory includes additional instructions executable by the processor to cause the computing device to render and surface the reply email as a new email to the email thread corresponding to the original email in the email client in response to determining that the received reply email does not include the data or metadata representing an email reaction token.

12. The computing device of claim 10 wherein the memory includes additional instructions executable by the processor to cause the computing device to output, on the second computing device, a notification identifying the original email, the user of the first computing device, and the selected one of the emojis by the user of the first computing device.

13. The computing device of claim 10 wherein the memory includes additional instructions executable by the processor to cause the computing device to output, in the emoji interface, a number of additional users who have responded with the one or more emojis to the original email.

14. The computing device of claim 10 wherein:
to determine whether the received reply email includes data or metadata representing the email reaction token includes to determine whether the reply email includes data or metadata representing a name of the email reaction token; and
to identify the one or more emojis includes to identify data or metadata representing the selected one of the multiple emojis as content of the email reaction token.

15. The computing device of claim 10 wherein:
to determine whether the received reply email includes data or metadata representing the email reaction token includes to determine whether the reply email includes data or metadata representing a name of the email reaction token; and
to identify the one or more emojis includes to identify data or metadata representing the selected one of the multiple emojis as content of the email reaction token or content in a body section of the reply email.

16. The computing device of claim 10 wherein:
to determine whether the received reply email includes data or metadata representing the email reaction token includes to determine whether the reply email includes data or metadata representing a name of the email reaction token; and
to identify the one or more emojis includes to identify data or metadata representing the selected one of the multiple emojis as content of the email reaction token or content in a body section of the reply email; and
the memory includes additional instructions executable by the processor to identify the original email to which the one or more emojis apply according to data representing a unique identifier of the original email in the reply email.

17. The computing device of claim 10 wherein to render and surface the identified one or more emojis as the emoji interface includes to update a displayed number corresponding to the identified one or more emojis, the number representing a quantity of users who have responded with the one or more emojis to the original email.

18. The computing device of claim 10 wherein to render and surface the identified one or more emojis as the emoji interface includes to update a displayed number corresponding to the identified one or more emojis in the emoji interface, the number representing a quantity of users who have responded with the one or more emojis to the original email and without appending the received reply email as a new email to the email thread corresponding to the original email.

19. The computing device of claim 10 wherein:
the reply email is a first reply email; and
the memory includes additional instructions executable by the processor to cause the computing device to:
upon receiving a second reply email,
determine whether the received second reply email includes data or metadata representing an email reaction token indicating that the received second reply email is an email reaction representing a comment to the original email; and
in response to determining that the received second reply email does not include data or metadata representing an email reaction token, render and surface the second reply email as a new email to the email thread corresponding to the original email in the email client.

20. The computing device of claim 10 wherein:
the reply email is a first reply email; and
the memory includes additional instructions executable by the processor to cause the computing device to:
upon receiving a second reply email,
determine whether the received second reply email includes data or metadata representing an email reaction token indicating that the received second reply email is an email reaction representing a comment to the original email; and
in response to determining that the received second reply email does not include data or metadata representing an email reaction token, render and surface the second reply email as a new email to the email thread corresponding to the original email in the email client and output, in the email client, an emoji interface configured to display and receive selection of one or more emojis from a user of the computing device.
